(19) United States
(12) Patent Application Publication
(10) Pub. No.: US 2016/0259850 A1
(43) Pub. Date: Sep. 8, 2016

(54) DATASTRUCTURE GENERATION AND APPLICATION

(71) Applicant: David A. McInnis, Custer, WA (US)

(72) Inventor: David A. McInnis, Custer, WA (US)

(21) Appl. No.: 15/059,185

(22) Filed: Mar. 2, 2016

Related U.S. Application Data
(60) Provisional application No. 62/127,209, filed on Mar. 2, 2015.
(60) Provisional application No. 62/302,659, filed on Mar. 2, 2016.

(51) Int. Cl. G06F 17/30; G06F 17/22; H04L 29/08; G06F 3/0484

(52) U.S. Cl. CPC G06F 17/30719; G06F 3/04842; G06F 17/2235; H04L 67/22; G06F 17/3089

(57) ABSTRACT

The disclosure is directed to computer systems, storage devices, and computer-implemented methods for creating or configuring a gist summary relating to linked underlying online content. The gist summary includes multiple summary descriptions of the underlying content, each describing the same underlying content according to separate interest perspectives. The gist summary displays the separate summary descriptions as separate gist components. The gist summary enables tracking of user selection of the gist according to the different gist components, allowing for analysis and ranking of the separate interest perspectives of the gist, and enabling more efficient use of limited display space.

### CROSS-REFERENCE TO RELATED APPLICATIONS

This non-provisional application claims the benefit of and priority to U.S. Provisional Patent Application Ser. No. 62/127,209, filed on Mar. 2, 2015, and entitled “DATASTRUCTURE GENERATION AND APPLICATION.” This non-provisional application also claims the benefit of U.S. Provisional Patent Application Ser. No. 62/302,659, filed on Mar. 2, 2016, and entitled “ENHANCED GIST INTERFACES.” Both of the foregoing provisional applications are expressly incorporated herein by this reference in their entireties.

### BACKGROUND

1. The Field of the Invention

Embodiments of the invention relate to the creation and application of unique data structures.

2. The Relevant Technology

The Internet has specific configurations that enable the creation and display of content. Some content is specifically defined by one or more data structures. In some instances, window frames are defined and allocated for the display of specialized content. The dimensions of the window frames can constrain the quantity of content displayed.

### BRIEF SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

As described herein, various methods, systems, and storage devices are provided for creating and utilizing data structures that can be used for facilitating the presentation of gists within predefined window frames on Internet webpages. The display attributes and content of the gists are defined by underlying data structures. The manner in which a user interacts with the gists can be used to facilitate granular mining of Internet traffic.

The gists, in some embodiments, include a plurality of different components that each comprise different content and which may be displayed in a similar or dissimilar manner (within a single predefined frame). These different gist components, while being visually distinguishable from one another (having different content and/or different presentation styles) all individually link back to a single source of content. Accordingly, when a user selects any one of the different gist components, the user is directed to the same linked content, regardless of which gist component is selected.

In some embodiments, the different gist components each correspond to different interest perspectives associated with the single source of content. The presentation style of the gist components can be selectably changeable to correspond to a context and/or other content in the surrounding environment where the gist is placed. For instance, the gist styling can take on a styling of a webpage in which the gist frame is positioned, such that a style of text and links in the gist matches a styling of text and links in surrounding text of the webpage.

Ordering of the gist components can also vary, in some embodiments, dynamically and in response to detected metrics associated with other user selection(s), such that more commonly selected gist components are ordered above/ahead of less commonly selected gist components. Ordering of gist components can also be based on detected contextual conditions of the surrounding webpage. For instance, if it is determined that a webpage is directed to a particular theme or audience, then gist components that most closely match that theme/audience can be ordered ahead of components that do not match as closely.

Different interfaces are provided to control the development of each of the different gist components, to control deployment of the gists, and to track of how the gist components are utilized.

Some embodiments also provide mechanisms for masking sources of the gist content from the hosts that present the gists within predefined windows on their webpages.

Additional features and advantages will be set forth in the description, which follows, and in part will be obvious from the description, or may be learned by the practice of the teachings herein.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered limiting in scope, embodiments will be described and explained with additional specificity and detail through the use of the accompanying drawings in which:

FIGS. 1-3 illustrate examples of interfaces that can be used for creating a gist and gist components.

FIG. 4 illustrates an interface for selecting rules for distributing gists.

FIG. 5 illustrates an interface for editorial scoring of gists.

FIG. 6 illustrates a preview interface of two gists that each have a plurality of different gist components.

FIGS. 7 through 10 illustrate different examples of gists having different placement formats.

FIG. 11 illustrates an embodiment of a gist that is displayed on a gist agent host.

FIG. 12 illustrates an embodiment in which the gist frames the linked content.

FIG. 13 illustrates an embodiment of a view that is presented to a viewer after the viewer selects a gist component and while the viewer is being redirected to the host of the linked content.

FIG. 14 illustrates an interface that can be used to analyze effectiveness of the gist placements and configurations.

FIG. 15 illustrates a flowchart of a method for generating or modifying a gist.

FIG. 16 illustrates a flowchart of a method for editorial modification of a gist.

FIG. 17 illustrates a flowchart of a method for managing distribution of a gist.

### DETAILED DESCRIPTION

Aspects of the disclosed embodiments relate to the creation and use of data structures that facilitate intuitive presentation of gists defined by underlying gist data structures and for facilitating mining of Internet traffic based on the structured presentation of the gist content. The disclosed embodiments also include interfaces that are used for facilitating the creation and use of the gists and deployment thereof, as well as the analysis of gist interactions.

Existing Internet interfaces enable a user to present web content in a variety of ways. When a user wants to distribute a link to their own content, they often utilize allocated spaces or frames on a plurality of different hosting webpages. These spaces or frames (e.g., banners, pop under frames, half page frames, popups, etc.) effectively limit the amount of content that can be displayed, by virtue of their size. Accordingly, it is typical for a user to limit their presentation content to a single image and a single line of text that is directed to a generic or single perspective of interest. Then, when a viewer selects the frame of presentation content, the viewer will be redirected to supplemental or source content (typically on a different webpage provided by a different host).

The source of the content typically compensates webpage hosts for allowing their links to be presented within the presentation frames on the hosted webpages. The compensation can be based on impressions created when the framed content is loaded, displayed and/or viewed. Compensation can also be based on click-throughs (i.e., when a user clicks on the displayed content and is redirected to the site associated with the linked content). A user may also compensate a distribution agent that distributes and places the content in the frames. Sometimes, links to content are displayed without any compensation, such as when the host of the webpage is simply trying to provide a variety of consumable content to their patrons.

While it can be fairly easy to determine when a viewer makes a selection of framed content, it is not very easy to mine the motivations and interests of the viewer and to differentiate between different motivations for selecting the linking content. This can also make it difficult to ensure that content is presented in such a way that is most desirable and accessible for consumers, based on their interests, understanding, and motivations.

The presently disclosed embodiments provide technical solutions to some of the foregoing problems by providing interfaces and systems for generating data structures that define gists associated with corresponding content. The gists and corresponding data structures are constructed with several discrete gist components that each corresponds to a different interest perspective or type of personality. In one embodiment, the gist components correspond to two, three, four or more different interest perspectives. These interest perspectives can include any set of predefined perspectives. In one embodiment, the interest perspectives include a competitive perspective, a humanizing or sympathizing perspective, a methodical perspective, and a spontaneous perspective. In such an embodiment, the competitive perspective corresponds to the rationale for why the underlying content is a ‘big idea.’ The humanizing and sympathizing perspective corresponds to how the underlying content can benefit humanity and/or the ethics of why it really matters. The methodical perspective corresponds to the functionality, ‘nuts and bolts,’ and other similar analysis of the underlying content. The spontaneous perspective corresponds to the innovative, new, freshness, and uniqueness of the underlying content.

In other embodiments, the different perspectives correspond to other demographic profiles, such as age, gender, interests, ethnicity, socio-economics, relative intelligence, affiliation, geographic location, and/or any other perspective or personality type.

Each of these gist components is specifically tailored to correspond to a different interest perspective, or different combination of interest perspectives, even though each of the gist components in a single gist corresponds to and links to the same underlying content. Accordingly, by placing the different gist components within a single framed gist, it is possible to mine viewer interests and effectiveness more granularly than previously possible with a single perspective promotional link. Accordingly, one technical effect of utilizing gists is the ability to electronically track and distinguishing between specific interest traits of the viewers, all from a single presentation of a single gist within the predefined dimensions of a placement frame/window (e.g., as defined by the IAB (Interactive Advertising Bureau)). The dimensions utilized for displaying the gist, including all gist components that are presented within a single gist, can also be defined by the gist publisher systems and/or the hosting webpage systems, among other possible size and position constraints.

In some embodiments, the gist is deployed in HTML or another native language/format of the hosting page/site. The gist includes sufficient computer-executable code for each of the different gist components to be presented as separate links to the same associated content. The computer-executable code also enables each of the gist components to be dynamically and selectably modified for a presentation that matches the context and/or style and overall look and feel of other content on the hosting webpage, so as to improve the viewer experience and the potential effectiveness for having viewers select the linked content.

To make the gist components modifiable in a dynamically responsive manner to the underlying context and/or style of the webpage, the gist data structures can include code for scanning the host styling and the context of the hosted content. This can be performed by scanning tags, text, CSS (cascading style sheet) data and other code and data of the hosted page; for example, scanning style and/or context of a page and modifying the gist may be handled using javascript, CSS, or other suitable scripting language. Then, the gist component(s) can be modified to utilize similar or predetermined modified styles. In some embodiments, this includes modifying a color, a highlighting scheme, a font size, a shading pattern, orientation, transparency, font property, and/or other feature. In other embodiments, this can include modifying words or terminology used in the caption of the gist component(s) and/or a type or style of language used to recite the captioning of the gist component(s). Modification can also include ordering of the gist components. Modification can also include changing a link address, which the viewer is directed to when the displayed content is selected, as well as which portion(s) of the displayed content comprise a link (i.e., a hyperlink).

Some modifications to the gist components are performed universally to all of the gist components. Other modifications are performed independently and differently to separate gist components, based on predetermined instructions and coding associated with each of the gist components and/or based on rules that track relationships between different types of contexts and different interest perspectives of the different gist components.

In some embodiments, the gist data structure has code that is operable to cause the modification independently of action by the host systems, prior to being provided to the host systems for display, such that the scanning and parsing of the host content is performed prior to the gist data structure being provided to the host systems.

In other embodiments, the gist data structure includes no instructions, or includes default instructions allowing or instructing the host to select and modify the presentation of the gist component(s) after it is initially received for presentation, based on settings and preferences of the host.

In yet other embodiments, an initial gist data structure is provided with a first set of display properties for each of the gist components. Then, subsequent to display of the gist, an updated set of display properties is provided to the host to modify the presentation of one or more of the gist components based on the updated display properties. The updated display properties can include changing content, changing a presentation style, changing an ordering, changing a display duration, changing a link address, combinations of the foregoing, and so forth.

In one embodiment, the gist components are presented differently than one another. For instance, a first gist component can comprise an image, a second gist component can comprise text that is bolded and that corresponds to a first interest perspective. A third gist component can comprise text that is unbolded and that corresponds to a different interest perspective. Fourth, fifth, and/or sixth gist components can also comprise different/unique captions of text that reflect yet additional corresponding interest perspectives. However, any number of different gist components can be used within the single gist and any combination of the gist components can comprise a selectable link to the underlying content.

In some embodiments, the ordering or positioning of the different gist components and/or the treatment of how the different gist components are presented (e.g., font styling) are dynamically modified in response to tracked data that reflects which of the components are selected most frequently and/or in response to tracked data that reflects a context in which the components were displayed when being selected.

There are various technical effects and benefits that can be achieved by implementing aspects of the disclosed embodiments. By way of example, the disclosed embodiments can be used to provide a more granular tool for tracking Internet traffic and for presenting tools for linking a single source of content to a plurality of different selectable links (e.g., each representing a different interest set or focus) in a single gist. The disclosed embodiments can also be used to improve user experience when viewing mixed content from multiple sources, and can be used to display mixed content in a way such that the content appears more seamless and/or consistent.

In addition, whereas display space is often limited by the inherent technical constraints of web page displays and user interfaces, which, by necessity, require limited display space to be allocated in a limited fashion. Disclosed embodiments enable content owners to maximize the value of the limited resource of display space by providing multiple interest perspectives in a single gist and further by enabling the tracking of relative levels of effectiveness between different interest perspectives of the gist, thereby enabling content owners to dynamically update, reorganize, and/or adjust the organization and structure of the gist in order to maximize use of the limited digital display space resource.

In some embodiments, the content linked to by the gist (when any of the gist components are selected) will cause the content to be displayed. This content can be displayed by a gist host (e.g., a distributor or creator of the gist). Alternatively, the linked content can be displayed by the source of the linked content (e.g., the source that commissioned the gist placement).

In some embodiments, the gist data structure includes code for causing a viewer to be redirected through the gist host to the content source, rather than having the user be linked directly to the content source by the hosting website of the gist. This can be done, in some embodiments, to protect or otherwise mask the identity of the content source from the third party hosting the website with the gist presentation. Redirecting may be handled, for example, through Javascript, PHP (Personal Home Page), or other suitable scripting language. Redirecting can also facilitate a more effective mining of viewer interaction and behavior, including inferred motivations and personality traits of the viewer. For instance, by redirecting, the gist host can easily determine which of the linked gist components were selected. If redirecting is not utilized, this selection data is extracted in other ways, such as by obtaining the data directly from the content source or from the host of the hosting website.

In some embodiments, the individual gist components are limited in size to a predefined quantity of characters that correspond to the limitations for broadcasting, redistributing and/or sharing on a blog or social platform such as Twitter, Facebook, Pinterest, Google plus, LinkedIn, or any other social media platform. In these embodiments, the gist can also include links which, when selected, cause one or more of the gist components to be automatically redistributed through the corresponding social media platform.

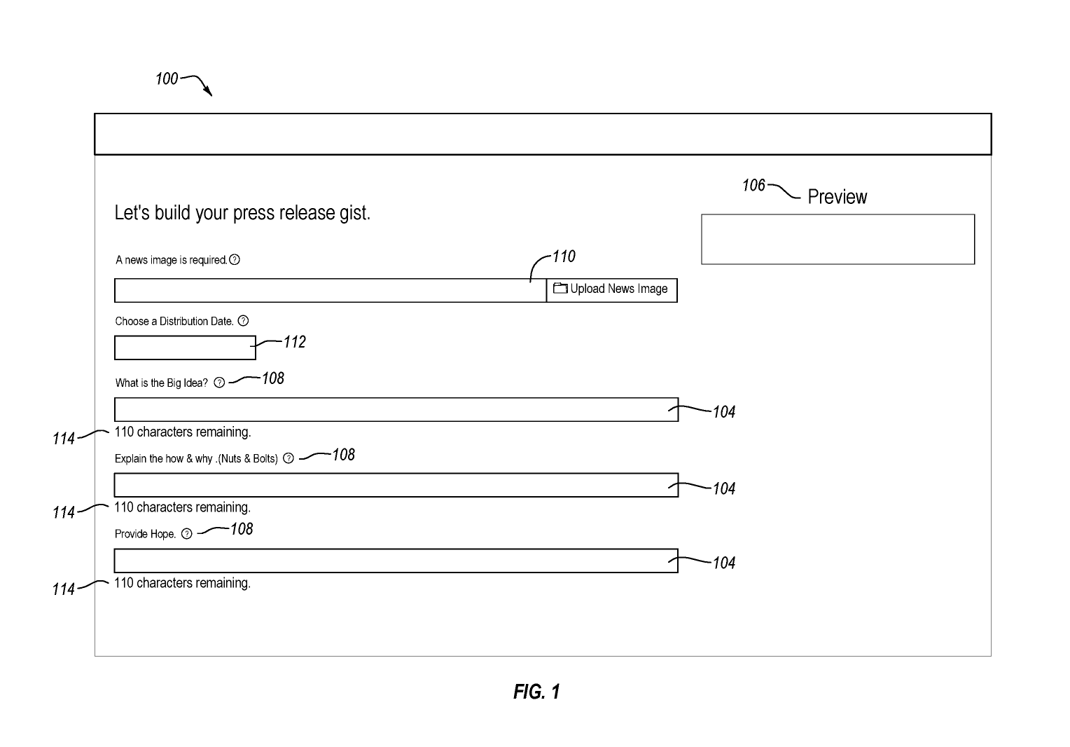

In some embodiments, interfaces are provided to facilitate the processes or flows that follow, for creating and/or utilizing aspects of a gist and gist components. These interfaces, can include, but are not limited to the interfaces shown in FIGS. 1-14.

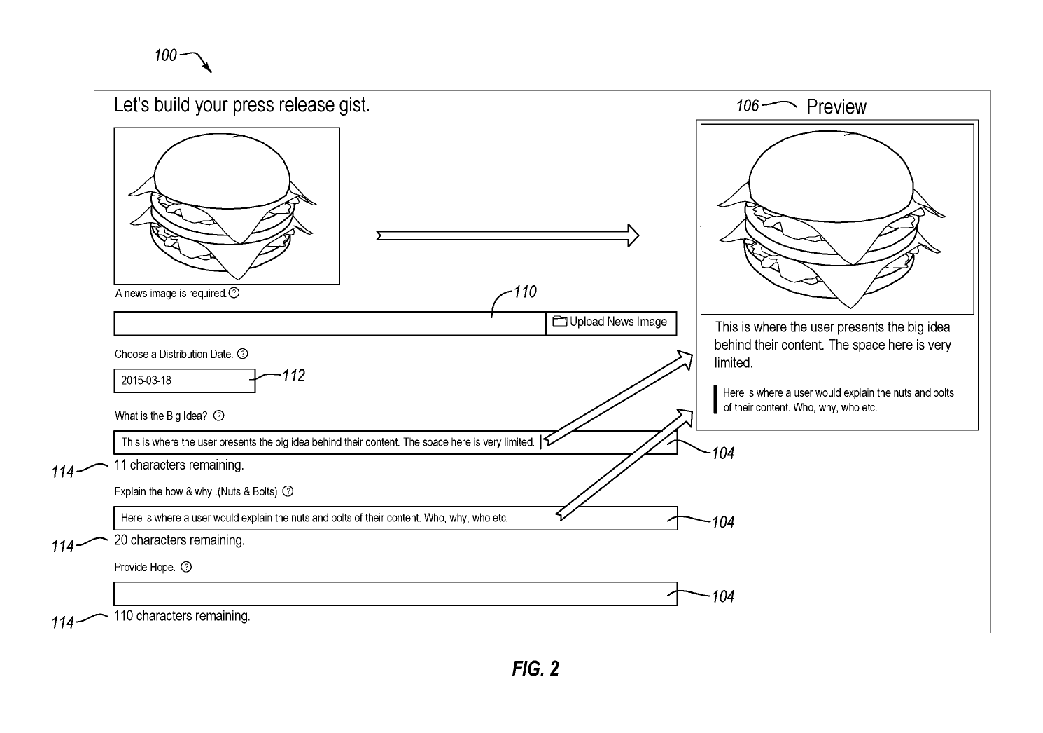

FIGS. 1-3 illustrate example interfaces that can be used for creating a gist and gist components. As shown by FIGS. 1 and 2, interface 100 includes selectable fields 104 for receiving user input that defines different interest perspectives associated with underlying content and for including image data and/or links to related content. As shown by comparing the interface view of FIG. 1 to the interface view of FIG. 2, the interface 100 also includes a preview 106 that is dynamically updated as users provide input to one or more of the fields 104. Although only a few fields 104 are shown for a selected number of interest perspectives (e.g., “Big Idea,” “Nuts & Bolts,” “Provide Hope”), any number and type of interest perspectives can be utilized.

Links 108 can be provided which, when selected, cause additional information to be provided to the user to educate the user about the input to provide. For example, for links 108 that are associated with fields 104 configured to receive input related to interest perspectives, the additional information can include additional descriptions of the interest perspective. Links 108 can also provide menu options for selecting presentation rules for controlling styles of presentation of the gist components. In the illustrated embodiment, these links 108 (e.g., to the additional information and/or menu options) are shown as selectable objects in the form of circled question marks. In other embodiments, other link displays and formats may be utilized.

In the illustrated embodiment, fields 110 and 112 are also provided for selecting a distribution date and for uploading image content. In addition, the interface 100 includes a number of input tracking displays 114, each associated with a corresponding field 104 and configured to display the number of additional characters that may be added to the field 104. For example, as shown in FIGS. 1 and 2, the fields 104 labeled “Provide Hope,” “Nuts & Bolts,” and “Big Idea” are each associated with a character tracking display 114 showing the number of characters remaining that may be input into the corresponding field 104. Currently, the character tracking displays 114 are shown in FIG. 1 as displaying 110 characters remaining for each of the foregoing fields, and in FIG. 2, as input has been received by the fields 104, as displaying a lower amount of remaining characters.

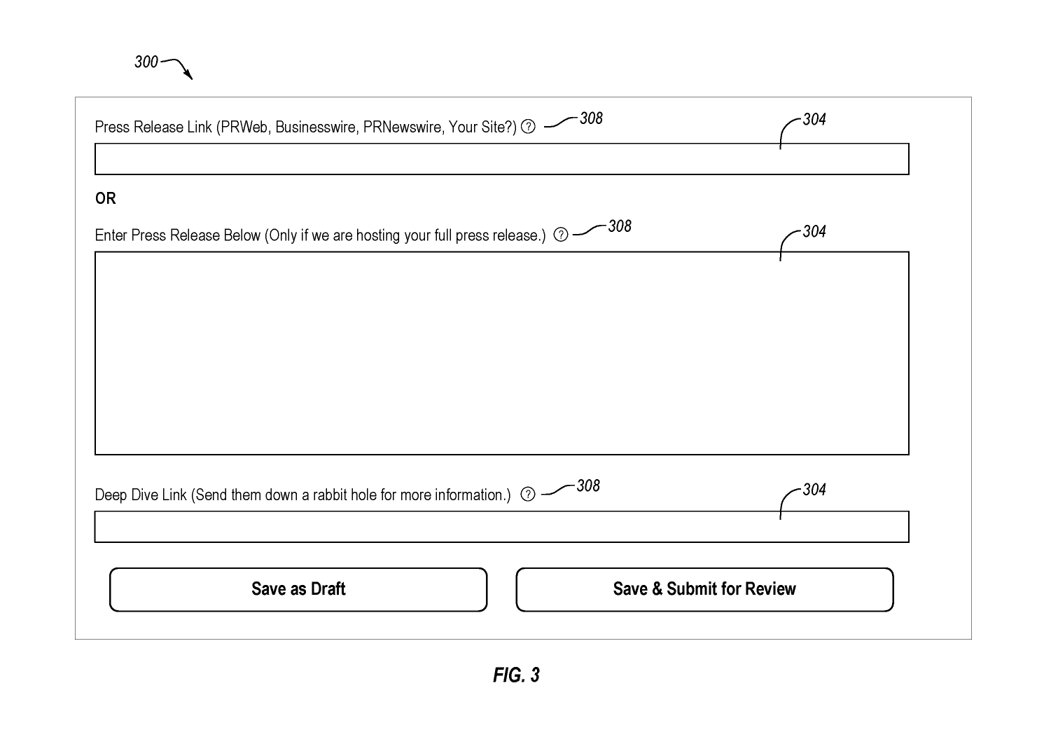

FIG. 3 illustrates a view of an interface 300 showing additional fields 304 and links 308. This embodiment includes fields for linking to press release information and for inputting additional links (e.g., “Deep Dive Link”). In other embodiments, other configurations of fields and links may be exhibited. For example, some embodiments may omit one or more of the fields and/or links, such as in implementations where gist display space is even more relatively limited and/or in implementations where one or more fields are less relevant or useful. Alternatively, some embodiments may include additional fields and/or links, enabling a user to input additional content descriptions, interest perspectives, related links (e.g., links to content related and/or relevant to the underlying content to which the gist is associated), gist display preferences, etc.

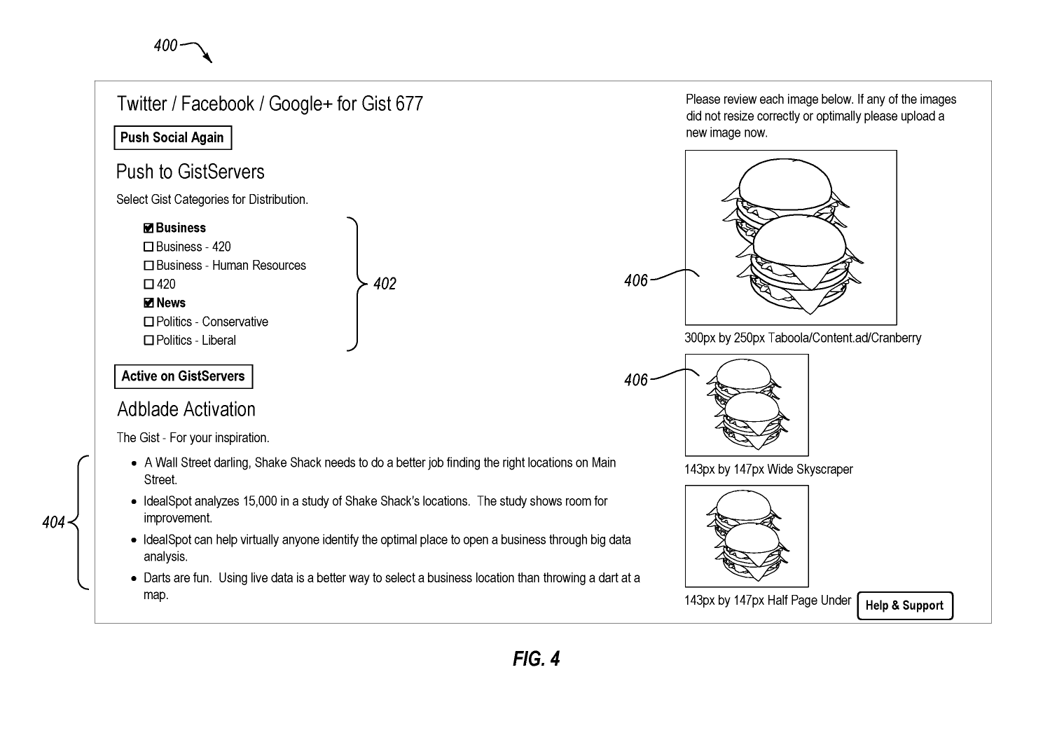

FIG. 4 illustrates an interface 400 for selecting rules for distributing the gist to different locations/sites. For example, the illustrated interface includes a plurality of user-selectable distribution categories 402. Each of the different distribution categories 402 can also be associated with different size formats 406 and placement locations on the corresponding websites (e.g., banner placements, popups, side screen placements, half screen, or any other placement). The interface 400 also displays a plurality of different gist components 404 representing different interest perspectives associated with the gist (e.g., as entered using the interface 100 of FIGS. 1-2).

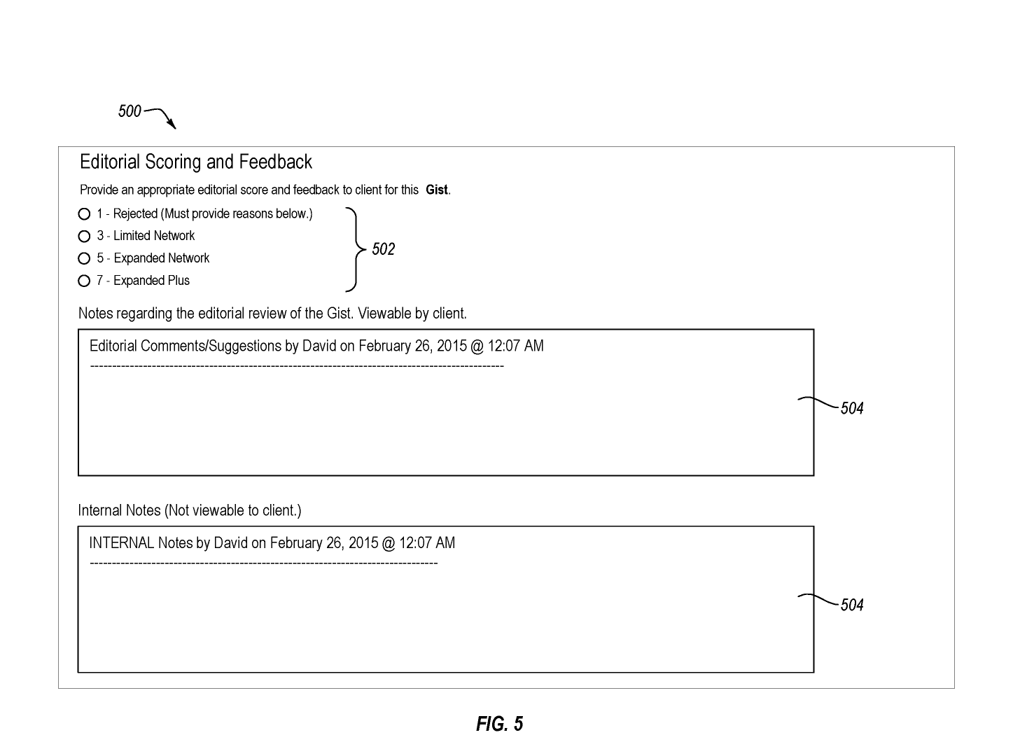

FIG. 5 illustrates an interface 500 for scoring a gist. The score can be used to control distribution to corresponding markets associated with different scores. The scoring can be done manually, by an editor, and/or automatically by parsing the gist components and comparing the parsed data to predefined scoring rules. For example, the illustrated interface 500 includes a number of fields 504 allowing an editor to provide comments/suggestions and to make notes related to the gist. The interface 500 also includes a score input field 502 (shown in this particular embodiment as a plurality of radio buttons) enabling an editor to input a score to be associated with the gist.

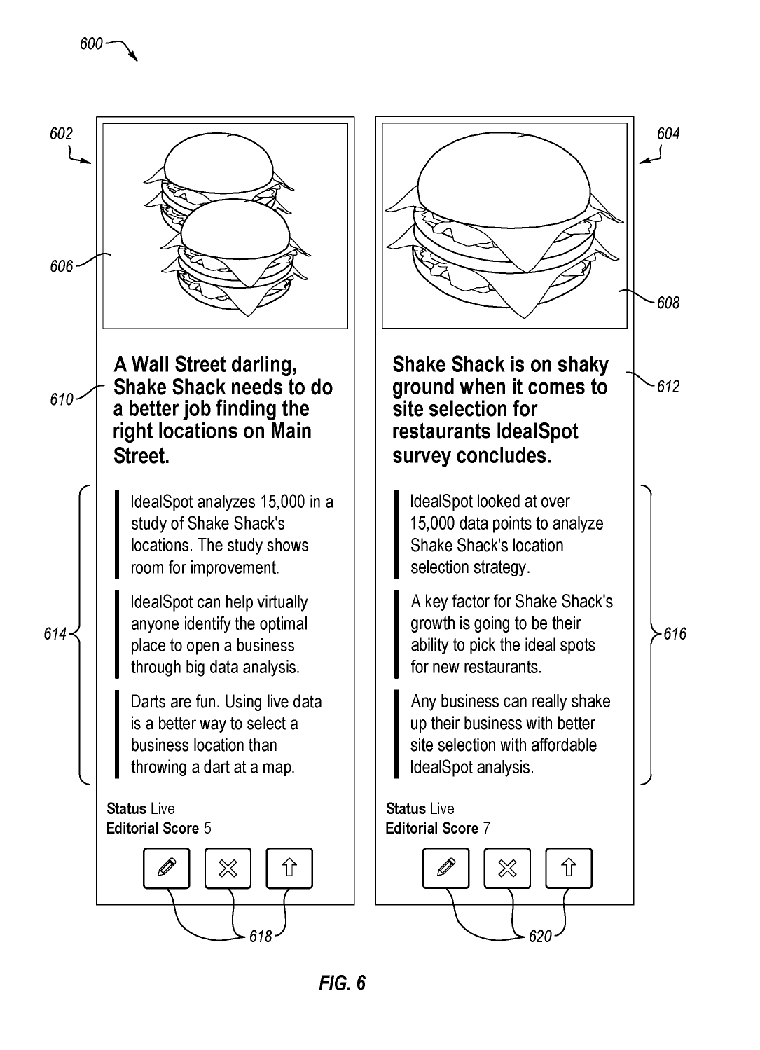

FIG. 6 illustrates a preview interface 600 of two gists 602 and 604 that each have a plurality of different gist components. Each set of gist components include different interest perspectives that link to a same asset of underlying content. The illustrated gists 602 and 604 each include an image gist component 606 and 608, a bolded textual component 610 and 612 directed to a first interest perspective, and a plurality of unbolded gist components 614 and 616 directed to different interest perspectives of the linked content. The illustrated gists also include additional object sets 618 and 620 enabling further operations to be performed on the gists (e.g., editing, deleting, archiving, submitting, saving, etc.).

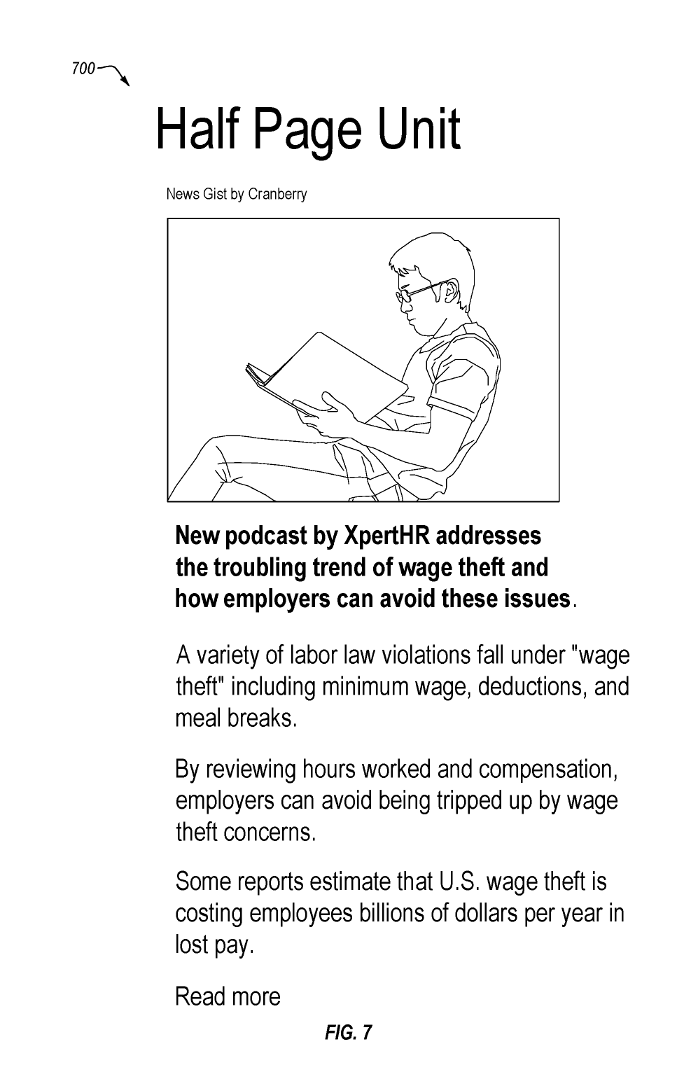

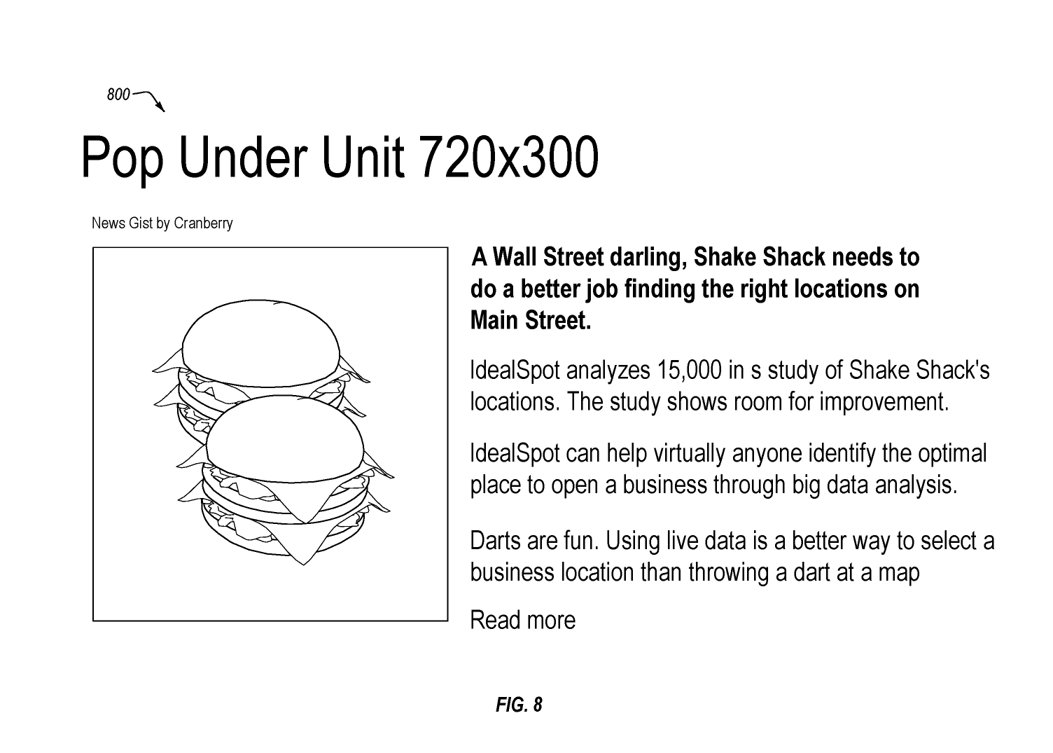

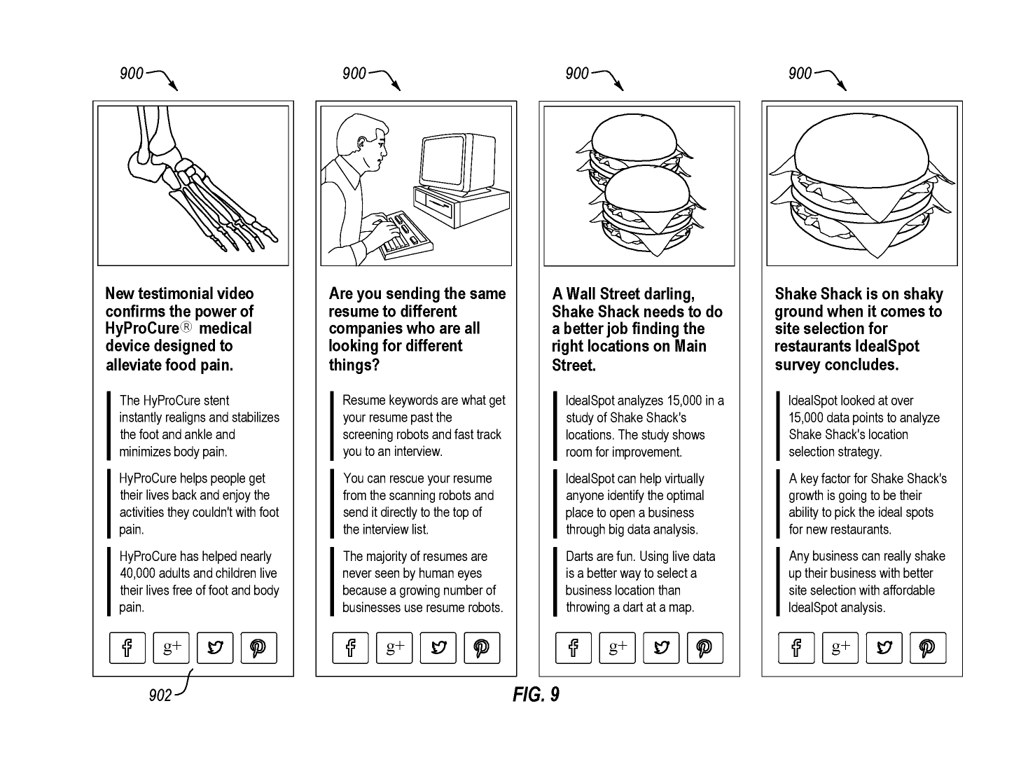

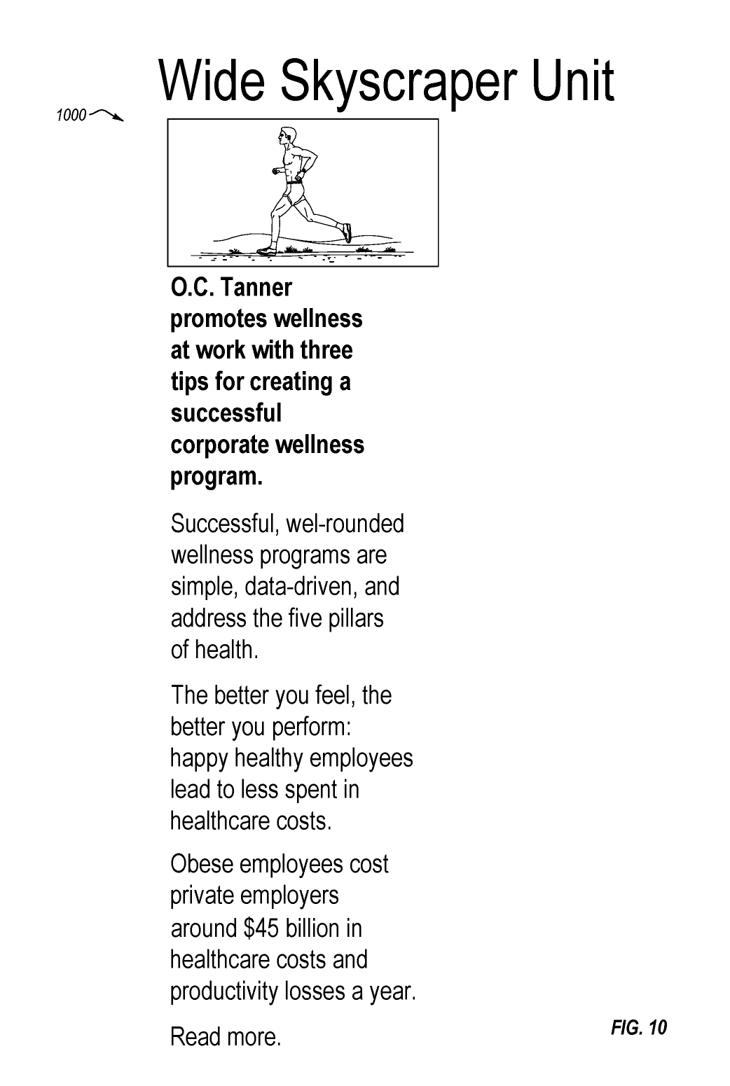

FIGS. 7 through 10 illustrate different examples of gist placement formats, including a half page placement of a gist 700 (FIG. 7), a pop under placement of a gist 800 (FIG. 8), a set of gists 900 in a side screen or small framed format that includes links 902 for redistributing over social media platforms (FIG. 9), and a wide skyscraper format of a gist 1000 (FIG. 10).

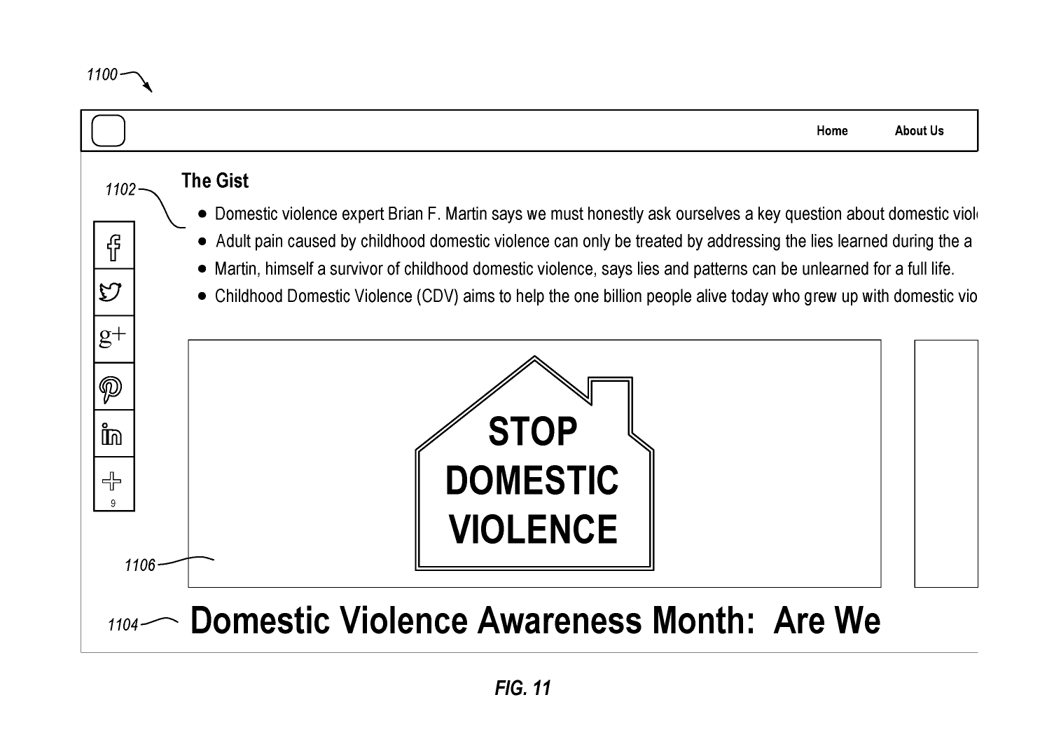

FIG. 11 illustrates an embodiment of an interface 1100 showing gist related content displayed on a gist agent host. In this embodiment, the gist components 1102 (including the gist image 1106) are presented at the top of the page, followed by a full presentation of the source content 1104 related to the gist. In this implementation, the source content 1104 follows the image 1106 and is accessible by the viewer scrolling down the page—the source content is not presently shown, other than a headline for the source content 1104.

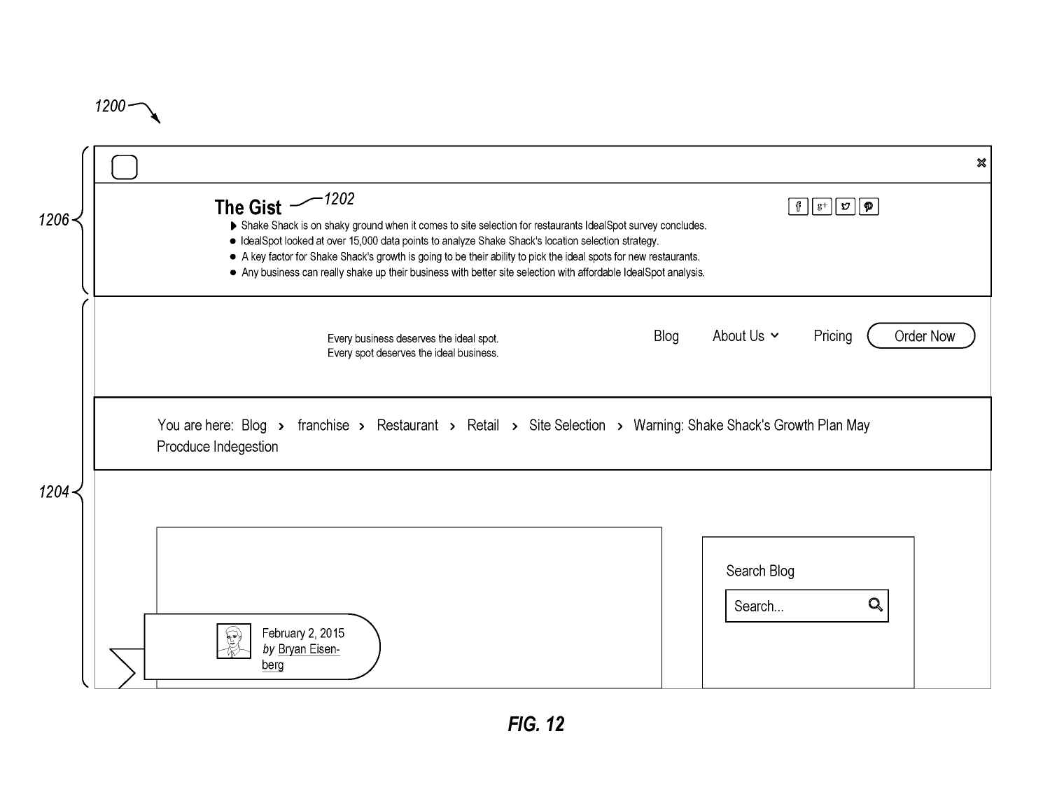

FIG. 12 illustrates an embodiment of an interface 1200 in which the gist 1202 frames the linked content 1204. The gist 1202 is presented at the top of the page in a frame 1206 that surrounds the linked content 1204 (in this implementation, showing blog content by “Bryan Eisenberg” related to “Every business deserves the ideal spot”). For example, the viewer may be presented with this view after selecting one of the gist components of the gist 1202 from a webpage hosted by a third party. In this embodiment, the gist host obtains and presents the linked content 1204 in a frame 1206 below the gist 1202.

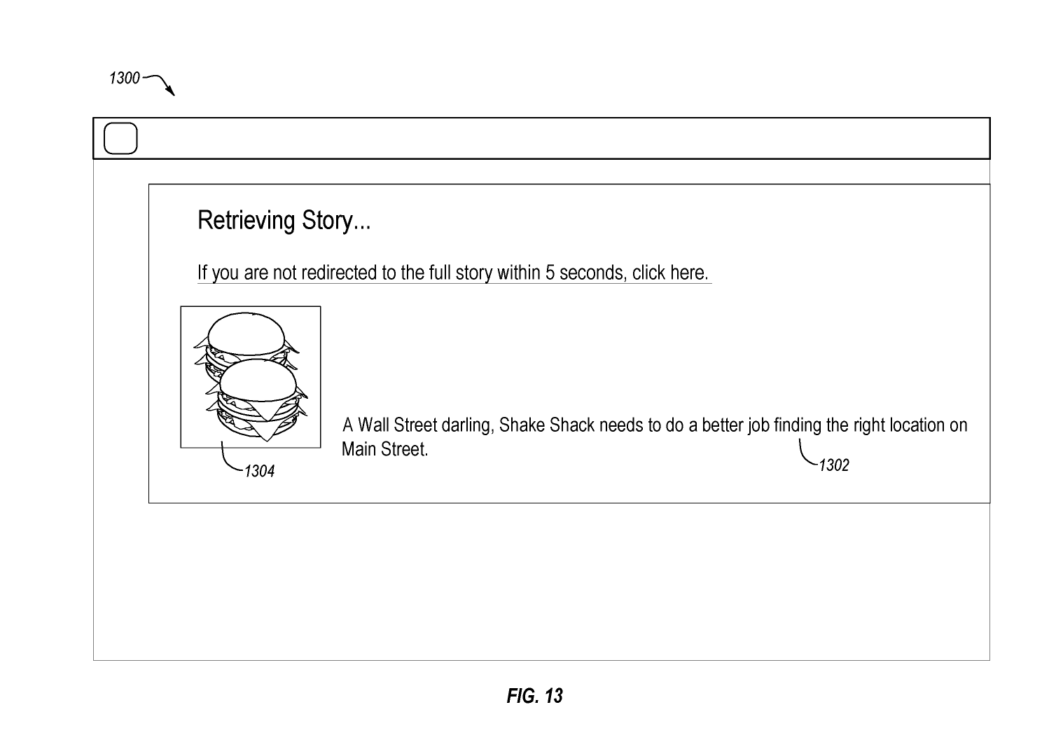

FIG. 13 illustrates an embodiment of an interface 1300 that is presented to a viewer after the viewer selects a gist component and while the viewer is being redirected to the host of the linked content (e.g., in circumstances where the source of the linked content or some other party displays the linked content as opposed to the gist host displaying the content). In the illustrated embodiment, the interface 1300 displays one or more of the gist components 1302 as the computer system is redirecting the interface to the linked content. For example, an interface can display the particular gist component that was selected, the highest-ranking gist component, the gist image 1304, or some other combination of gist components. Alternatively, the entire gist can be displayed. After being redirected, the gist can be presented with the linked content, as in the other examples (e.g., presented in the manner illustrated by FIG. 11 or FIG. 12). Alternatively, the linked content can be presented without the gist or gist components.

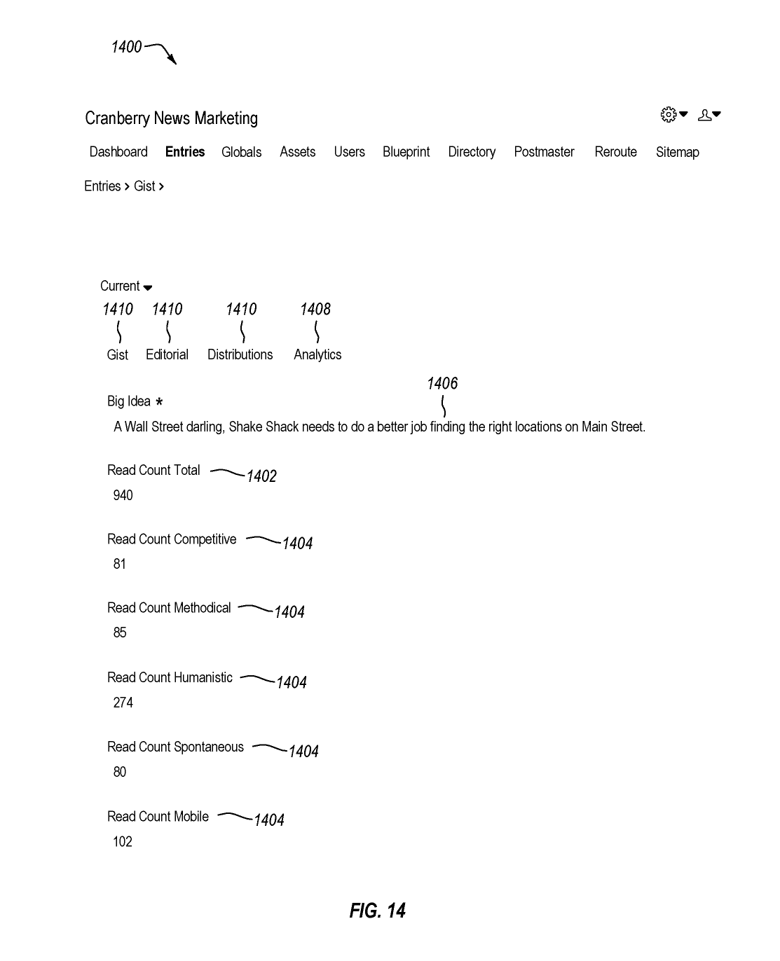

FIG. 14 illustrates an interface 1400 that can be used to analyze effectiveness of the gist placements and configurations. The interface 1400 includes different fields 1404 that correspond to different interest perspectives for the same gist and which can be used to identify which gist components within the gist were selected by viewers desiring to see the underlying linked content. As shown by this embodiment, each of the separate interest perspective fields 1404 are displayed with a “read count” indicating the number of times the particular gist component and associated interest perspective was selected by a user (e.g., the number of click-throughs of the gist component). This data is mined, as described before, from the webpage host, the gist host, and/or the content source host. The illustrated interface 1400 also includes a read count total field 1402 indicating the total number of times the gist (i.e., any gist component of the gist) was selected/clicked on by a user, as well as a field 1406 displaying at least a portion of the text of the gist (such as the “Big Idea” component in this particular example).

Other linked data is accessible in response to a user selecting one of the displayed links, such as the analytics link 1408, to further identify more granular data, such as profiles of viewers, profiles of webpages hosting the gist, how such profiles associate with the read count data (e.g., for a given profile or combination of profiles, identifying the associated breakdown of read counts for the different interest perspectives of the gist), and so forth. Additional links 1410, such as for editing the gist and/or for modifying distribution and presentation rules are also provided. When selected, links 1410 direct the user to interface menus for modifying the corresponding gist components and rules, such as to one or more of the other interfaces described herein.

The data presented in the interface 1400 of FIG. 14 and other linked data (e.g., data linked through the analytics menu) is usable to control modification to the gist, including modification of the gist component positioning or ordering, modification of term usage, presentation style, language, and/or any other modification. In some embodiments, this metric data is used to automatically generate an updated set of gist presentation parameters that are suggested to improve effectiveness of the gist and which can be manually or automatically sent to webpage hosts to update existing gist presentations. These modifications can include use, sizing, interest perspective ordering, and placement of images within the gist frame, as well as the overall size and location of the gist within a webpage.

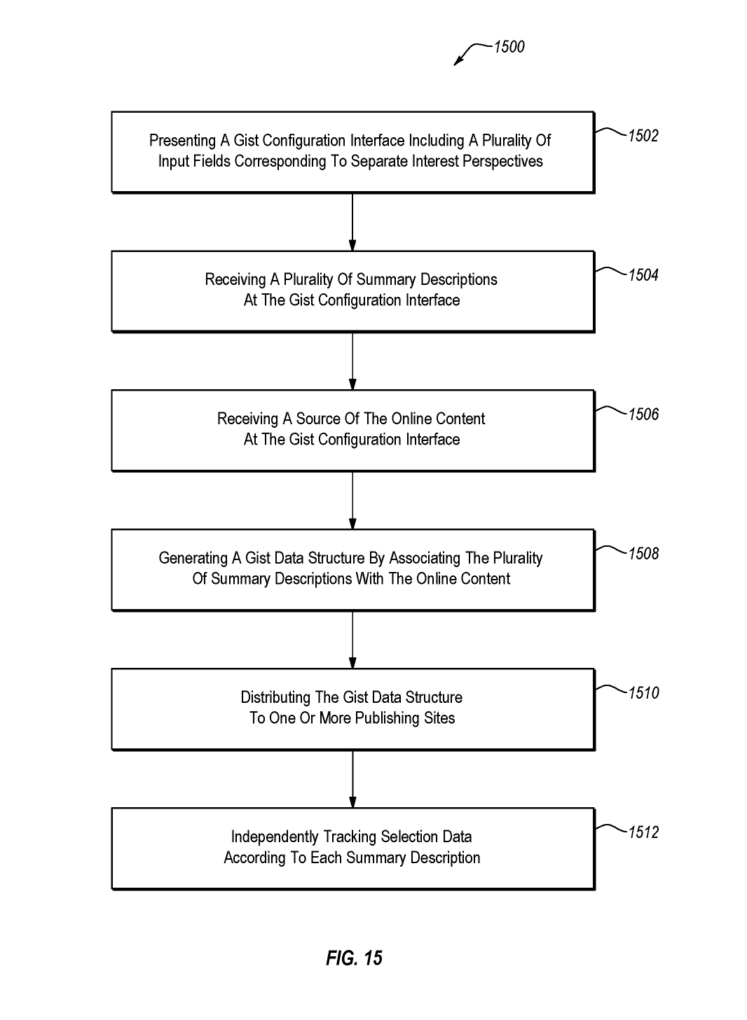

FIGS. 15-17 illustrate process flows associated with the creation and use of the gists, corresponding, respectively, to a user system experience or perspective, an editorial system experience or perspective and a distribution or administrator system experience or perspective.

FIG. 15 illustrates a flowchart of a method 1500 for creating and/or configuring a gist. In some embodiments, the method may be performed using one or more of the interfaces described herein, such as the interfaces illustrated by FIGS. 1-4 and FIG. 6.

The illustrated method 1500 includes presenting a gist configuration interface including a plurality of input fields corresponding to separate interest perspectives (1502), each input field configured to receive a summary description summarizing at least a portion of the online content according to the corresponding interest perspective of the input field. For example, a plurality of fields may be presented, wherein each field is configured to receive input associated with separate aspects or interest perspectives of the online content. As used herein, “online content,” “linked content,” and the like can refer to one or more webpages, information related to a multimedia asset, online sites, etc.

In some embodiments, a login interface is also presented and login credentials are received from a user at the login interface prior to presenting the gist configuration interface. For example, users or other entities desiring to promote online content and/or multimedia assets may register with a gist hosting service.

In some embodiments, at least one of the presented fields is configured to receive a gist image representative of the online content. In some embodiments, a presented field is configured to receive a selected distribution date indicating a desired date of distribution of the gist (e.g., date on which the gist will be distributed according to selected and/or determined distribution categories).

The illustrated method 1500 includes receiving a plurality of the summary descriptions at the gist configuration interface (1504). For example, one or more of the presented fields are configured to receive input associated with different interest perspectives (e.g., different consumer temperaments and/or any of the separate interest perspectives described herein), and the summary descriptions are received as the corresponding information is entered into the interest perspective fields.

In some embodiments, one or more instructions (e.g., questions about the content) designed for eliciting responses that correspond to the separate interest perspectives are also presented at the interface. In some embodiments, an inline help screen for providing ideas and/or examples for answering the one or more questions is also presented.

In some embodiments, a sample of the gist is displayed as the gist is being built (i.e., as the input described above is being received at the interface). For example, the gist sample may be updated dynamically as the build input for the gist is received. In some embodiments, feedback for one or more of the fields is displayed, indicating the length of the received input for each field, and also indicating the remaining length available (e.g., remaining number of characters) for the particular input response.

The illustrated method 1500 includes receiving a source of the online content at the gist configuration interface (1506). For example, in some embodiments, the interface includes a content source field configured for receiving a link to the online content associated with the gist (e.g., the content to be promoted by the gist). In alternative embodiments, the interface includes a content source field configured for receiving the online content or multimedia asset directly (e.g., images and text may be entered directly into the interface). In some embodiments, the received content may then be hosted by the service performing the method and/or providing the interface. In some embodiments, both types of content source fields (one for receiving a link and one for receiving content directly) are presented simultaneously, such that a user may elect to provide a link or to provide content directly by entering the appropriate input into the appropriate corresponding field.

In some embodiments, the interface includes options for saving the gist. Such options can include an option for saving the gist as a draft such that later editing or approval is allowed, and an option for submitting the gist for editorial review.

The illustrated method 1500 includes generating a gist datastructure by associating the plurality of summary descriptions with the online content (1508), the gist datastructure being operable to cause a visual representation of the gist for showing the plurality of received summary descriptions as separate gist components, wherein each gist component links to the online content. For example, as described herein, the gist datastructure can be distributed to one or more publishing sites for display at the one or more publishing sites.

In some embodiments, one or more generated gists can be presented in a user-interactable form (i.e., in an editing mode) enabling modification or updating of the gists. This can be done prior to active distribution of the gists and/or during active distribution. For example, gist components of the generated gist can be modified, rearranged, etc., links can be altered, and other edits as described herein can be made to the gist configuration.

Additionally, or alternatively, one or more gists presented in an editing mode include a user-selectable option to modify (e.g., upgrade) a selected distribution profile. In some embodiments, the set of available distribution options for a given gist is determined by an editorial score assigned to the gist by an editor, by a system algorithm, or by some combination of algorithm and editor scoring.

In some embodiments, the interface is configured to receive one or more selected distribution options corresponding to the one or more generated gists. In some embodiments, payment corresponding to the one or more selected distribution options is received and/or an invoice corresponding to the one or more selected distribution options is generated. Some embodiments include one or more user-selectable options enabling the display of payment/invoice history.

In some embodiments, a gist presented in an editing mode includes a user-selectable option to delete and/or archive the gist. In some embodiments, a gist presented in an editing mode includes a user-selectable option for providing the display of analytical and statistical information relating to the gist (e.g., total hits, breakdown of hits according to interest perspectives, etc.).

The illustrated embodiment 1500 also includes distributing the gist datastructure to one or more publishing sites (1510) for display of the gist at the one or more publishing sites, and independently tracking selection data according to each summary description (1512) at the one or more publishing sites, the selection data independently tracking click-throughs for each of the separate gist components. Tracking of the gist components in this manner enables a content source to compare the overall effectiveness of the gist as well as the effectiveness of separate gist components relative to one another. This data enables automatic or manual reconfiguring of the gist to increase effectiveness of the gist within the limited display space available to the gist.

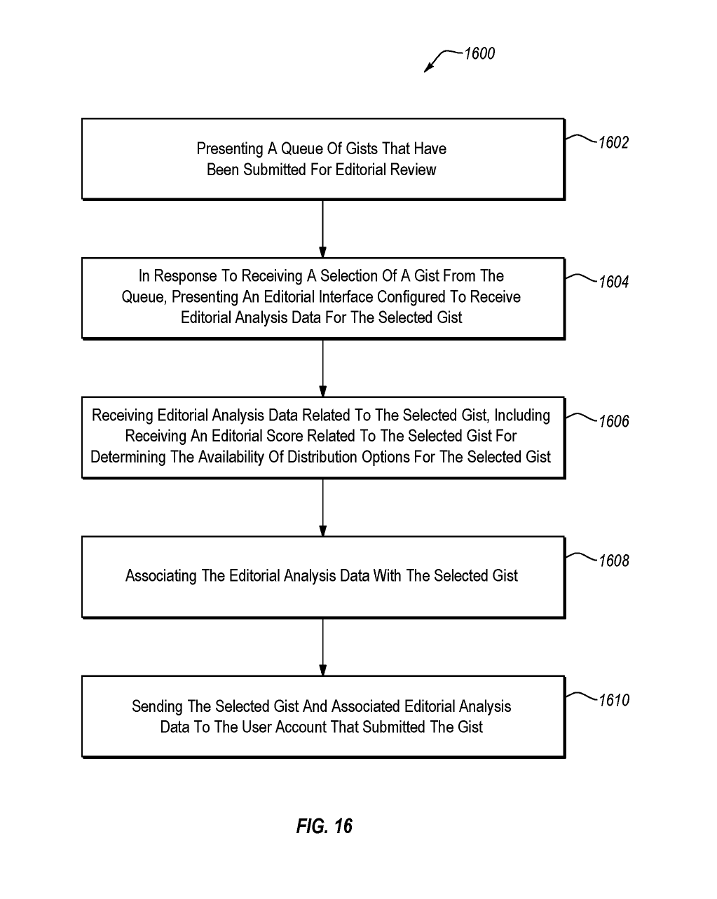

FIG. 16 illustrates a flowchart of a method 1600 for editorializing of a gist. In some embodiments, the method 1600 may be performed using one or more of the interfaces described herein, such as the interface illustrated by FIG. 5.

The method 1600 includes presenting a queue of gists that have been submitted for editorial review (1602). In some embodiments, a login interface and is also presented and login credentials are received from a registered editor prior to presenting the queue of generated gists to the registered editor.

The method 1600 further includes, in response to receiving a selection of a gist from the queue, presenting an editorial interface configured to receive editorial analysis data for the selected gist (1604), including data for establishing the availability of one or more distribution categories for the selected gist. For example, the editorial interface may enable an editor to change or modify configuration of the gist, including changing or modifying the gist image, content related to one or more of the gist components, titles (e.g., headlines), and response input lengths, for example. In addition, the interface enables the automatic or manual entry of an editorial score used to determine the availability of distribution options.

The illustrated method 1600 further includes receiving editorial analysis data related to the selected gist, including receiving an editorial score related to the selected gist for determining the availability of distribution options for the selected gist (1606). For example, the editorial interface can include a scoring field enabling the editor to enter an editorial score for the selected gist. Alternatively, the score may be entered automatically according to one or more algorithms or data analyses of the submitted gist. The scoring field can be represented by a set of numbers within a given range (e.g., 1 to 10).

In some embodiments, additional editorial analysis data related to the selected gist is received. For example, in some embodiments, the editorial interface also includes one or more of: an object enabling the editor to indicate whether the link to the underlying content of the gist requires particular handling (e.g., requires the use of frame-busting implementation); a field configured to receive internal notes available to other editors and/or administrators of the site/service; and a field configured to receive comments, feedback, and/or instructions to be made available and viewable to the user submitting the gist.

The illustrated method 1600 further includes associating the editorial analysis data with the selected gist (1608), and sending the selected gist and associated editorial analysis data to the user account that submitted the gist (1610), such as via an email communication or other delivery method. For example, the response can contain gist disposition information indicating the editorial score, feedback, further instructions, options, editorial comments, an indication of available distribution categories, and/or combinations of the foregoing.

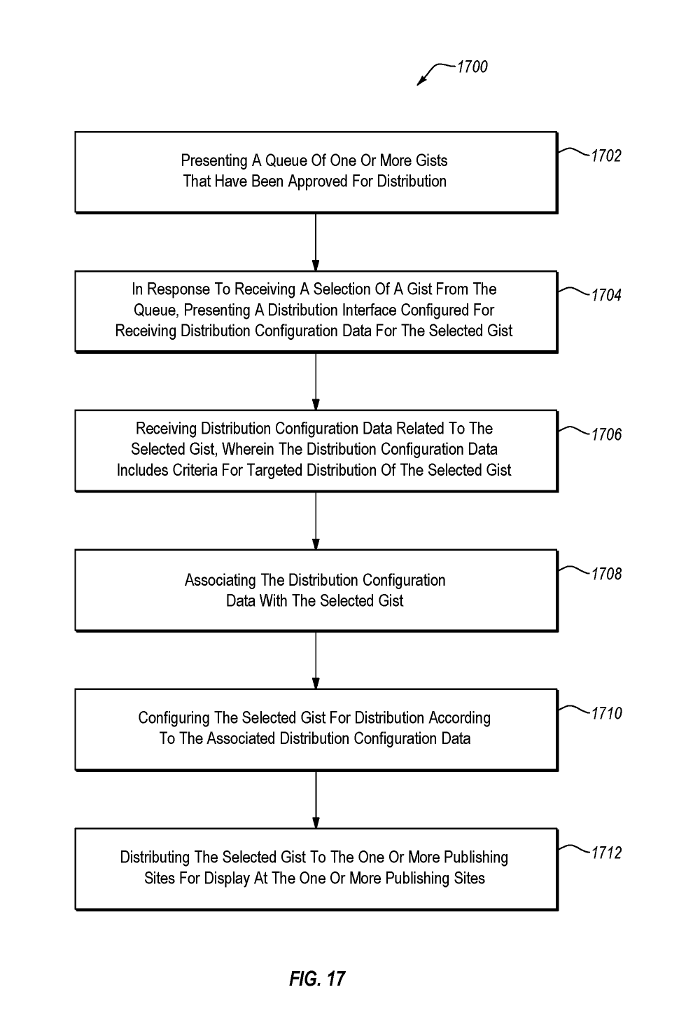

FIG. 17 illustrates a flowchart of a method 1700 for managing distribution of a gist. In some embodiments, the method 1700 may be performed using one or more of the interfaces described herein, such as the interface illustrated by FIG. 4.

The method 1700 includes presenting a queue of one or more gists that have been approved for distribution (1702). In some embodiments, a login interface is presented and login credentials are received from a distribution administrator at the login interface prior to presenting the queue of approved gists to the distribution administrator.

The method 1700 further includes, in response to receiving a selection of a gist from the queue, presenting a distribution interface configured for receiving distribution configuration data for the selected gist (1704). In some embodiments, the distribution interface includes a distribution configuration field configured to receive criteria for targeted distribution of the selected gist. For example, the distribution configuration field can include a list of available options for distribution channels, target demographics, topical categories, etc.

In some embodiments, the distribution interface includes a social push option enabling the gist to be pushed out to various (e.g., predetermined or selected) social media sites in configurations that are acceptable by the receiving social media channel (e.g., within character limits, image size constraints, etc.). For example, the gist may be broken down into chunks (e.g., separate pieces of text or images), where each chunk is targeted to a separate interest perspective and pushed separately to the social media sites. In some embodiments, a chunk includes a link that is configured to enable identification of the interest perspective associated with the chunk (e.g., for analytical tracking of click-throughs).

The method 1700 further includes receiving distribution configuration data related to the selected gist, wherein the distribution configuration data includes criteria for targeted distribution of the selected gist (1706), and associating the distribution configuration data with the selected gist (1708). The method 1700 further includes configuring the selected gist for distribution according to the associated distribution configuration data (1710), and distributing the selected gist to the one or more publishing sites for display at the one or more publishing sites (1712). For example, the gist can be configured to conform to various sizes suitable for display on different publisher sites, mobile device platforms, and/or other digital platforms. In some embodiments, the gist is configured for distribution in native HTML format utilizing an appropriate language (e.g., javascript, CSS).

In some embodiments, a distributed gist is configured to be displayed according to the native styling (e.g., font style, font size, color scheme, and/or gist shape) of a given publisher site to which it is distributed. Alternatively, a gist may be configured to be displayed in a non-native styling (e.g., where a publisher chooses a non-native gist for its site).

In some embodiments, the distribution interface includes one or more additional fields configured for receiving additional gist distribution input. For example, one or more fields may be included enabling the entry of data and/or selections for promotion of the selected gist through one or more partner channels.

A few additional embodiments and descriptions related to some exemplary gist characteristics will now be provided. In some embodiments, gists are distributed to a publisher site via iFrame or Javascript. Gists may be distributed in a native format or in a standard format. Standard format gists include internal style instructions (e.g., internally referenced cascading style sheets (CSS)) controlling the display style of the gist. Native format gists omit such style instructions, and are configured to assume the overall look and feel of the publisher site to which they are distributed by incorporating styling instructions from the publishers own style instructions (e.g., cascading style sheets (CSS)).

A few additional embodiments and descriptions related to some exemplary gist distribution methods will now be provided. In some embodiments, when an online content consumer clicks on any linked asset within a gist that resides at the publisher's site (or on a partner site or with a mobile placement) the user is redirected to the full content or multimedia asset via one of three delivery methods. In a “Redirect” delivery method, the user is briefly sent to a page hosted with the service and redirected to the full content or multimedia asset. In a “Framed Content” delivery method, the user is presented with the full content or multimedia asset framed within a site page hosted by the gist service. In a “Hosted Content” delivery method, the content is hosted and presented to the user from a page hosted by the gist service.

Various methods, computing systems and storage devices will now be described with reference to the disclosed embodiments for creating and utilizing data structures that define gist components.

In this description and in the claims, the term “computing system” is defined broadly as including any device or system (or combination thereof) that includes at least one physical and tangible processor, and a physical and tangible memory capable of having thereon computer-executable instructions that may be executed by the processor.

In its most basic configuration, a computing system includes at least one processing unit and memory. The memory may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

As used herein, the term “executable module” or “executable component” can refer to software objects, routings, or methods that may be executed on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. For example, such computer-executable instructions may be embodied on one or more computer-readable media that form a computer program product. An example of such an operation involves the manipulation of data. The computer-executable instructions (and the manipulated data) may be stored in the memory of the computing system.

The computer-executable instructions may be used to implement and/or instantiate all of the disclosed functionality, particularly as disclosed in reference to the methods described herein, including the creation and use of the gist components and the underlying data structures. The computer-executable instructions are also to implement and/or instantiate all of the interfaces disclosed herein.

The computing system may also contain communication channels that allow the computing system to communicate with other message processors over, for example, a network.

Embodiments described herein may comprise or utilize special-purpose or general-purpose computer system components that include computer hardware, such as, for example, one or more processors and system memory. The system memory may be included within the overall memory. The system memory may also be referred to as “main memory,” and includes memory locations that are addressable by the at least one processing unit over a memory bus in which case the address location is asserted on the memory bus itself. System memory has been traditionally volatile, but the principles described herein also apply in circumstances in which the system memory is partially, or even fully, non-volatile.

Embodiments within the scope of this disclosure also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical hardware storage devices that store computer-executable instructions and/or data structures. Physical hardware storage devices include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the principles described herein may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like.

The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

Alternatively, or in addition, the functionality described herein can be performed, at least in part, by one or more hardware logic components. For example, and without limitation, illustrative types of hardware logic components that can be used include: Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

When the referenced acts of the disclosed methods are implemented in software, the one or more processors of the computing system perform the acts and direct the operation of the computing system in response to having executed the stored computer-executable instructions defined by the software. Various input and output devices, not illustrated, can be used by the computing system to receive user input and to display output in accordance with the computer-executable instructions.

We claim:

1. A computer system, comprising:
one or more processors; and
one or more computer readable media having stored thereon computer-executable instructions that, when executed by the one or more processors, cause the computing system to configure a gist, the gist linking to online content and summarizing at least a portion of the online content, including instructions that are executable to cause the computer system to at least:
present a gist configuration interface including a plurality of input fields corresponding to separate interest perspectives, each input field configured to receive a summary description summarizing at least a portion of the online content according to the corresponding interest perspective of the input field;
receive a plurality of the summary descriptions at the gist configuration interface;
receive a source of the online content at the gist configuration interface; and
generate a gist datastructure by associating the plurality of summary descriptions with the online content, the gist datastructure being operable to cause a visual representation of the gist for showing the plurality of received summary descriptions as separate gist components, wherein each gist component links to the online content.

2. The computer system of claim 1, wherein the gist configuration interface includes a content link field configured to receive a link to the online content, and wherein associating the plurality of summary descriptions with the online content is accomplished by associating the plurality of summary descriptions with the link to the online content.

3. The computer system of claim 1, wherein the gist configuration interface includes a distribution date field configured to receive a distribution date indicating a desired date of distribution of the gist.

4. The computer system of claim 1, wherein the gist configuration interface includes one or more instructions for eliciting responses that correspond to the separate interest perspectives.

5. The computer system of claim 1, wherein the computer-executable instructions also include instructions that that are executable to cause the computer system to display a sample of the gist.

6. The computer system of claim 5, wherein the sample of the gist is updated and displayed dynamically as information is received by the gist configuration interface.

7. The computer system of claim 1, wherein the gist configuration interface includes one or more input tracking displays each associated with an input field, the one or more input tracking displays configured to display the number of additional characters that may be added to the associated input field.

8. The computer system of claim 1, wherein the computer-executable instructions also include instructions that are executable to cause the computer system to distribute the gist datastructure to one or more publishing sites for display of the gist at the one or more publishing sites.

9. The computer system of claim 8, wherein the computer-executable instructions also include instructions that are executable to cause the computer system to track selection data at the one or more publishing sites, the selection data independently tracking click-throughs for each of the separate gist components.

10. The computer system of claim 9, wherein the computer-executable instructions also include instructions that are executable to cause the computer system to present an analysis interface displaying gist analysis information, the gist analysis information including a total read count for the gist and read counts for each separate gist component.

11. The computer system of claim 8, wherein the computer-executable instructions also include instructions that are executable to cause the computer system to, in response to receiving a user selection of a gist component at the one or more publishing sites, display the online content as a host of the online content.

12. The computer system of claim 1, wherein the gist configuration interface includes an image input field configured to receive an image related to the online content, the image being associated with the online content as a gist component of the gist datastructure.

13. A computer system, comprising:
one or more processors; and
one or more computer readable media having stored thereon computer-executable instructions that, when executed by the one or more processors, cause the computing system to modify a gist, the gist linking to online content and summarizing at least a portion of the online content, including instructions that are executable to cause the computer system to at least:
present a queue of one or more gists that have been submitted for editorial review;
in response to receiving a selection of a gist from the queue, present an editorial interface configured to receive editorial analysis data, including data for establishing the availability of one or more distribution categories for the selected gist;
receiving, at the editorial interface, editorial analysis data related to the selected gist, the editorial analysis data including an editorial score related to the selected gist, the editorial score functioning to determine the availability of one or more distribution categories for the gist;
associating the editorial analysis data with the selected gist; and
sending the selected gist and associated editorial analysis data to a user account that submitted the gist.

14. A computer system, comprising:
one or more processors; and
one or more computer readable media having stored thereon computer-executable instructions that, when executed by the one or more processors, cause the computing system to distribute a gist, the gist linking to online content and summarizing at least a portion of the online content, including instructions that are executable to cause the computer system to at least:
present a queue of one or more gists approved for distribution;
in response to receiving a selection of a gist from the queue, present a gist distribution interface configured for receiving distribution configuration data for the selected gist;
receive distribution configuration data related to the selected gist, wherein the distribution configuration data includes criteria for targeted distribution of the selected gist;
associate the distribution configuration data with the selected gist;
configure the selected gist for distribution to one or more publishing sites according to the associated distribution configuration data, including conforming the gist to different sizes suitable for display at the one or more publishing sites; and
distribute the selected gist to the one or more publishing sites for display at the one or more publishing sites.

15. The computer system of claim 13, wherein the distribution interface includes a social push option that, upon selection, operates to push the gist out to one or more social media sites in configurations that are acceptable by the receiving social media sites.

16. The computer system of claim 13, wherein the distributed gist is configured to be displayed according to a native styling of a given publisher to which it is distributed.

17. The computer system of claim 13, wherein the distributed gist includes internal style instructions controlling the display style of the gist.

18. The computer system of claim 13, wherein the computer-executable instructions also include instructions that are executable to cause the computer system to, in response to receiving a user selection of a gist component at the one or more publishing sites, display the online content as a host of the online content.

19. The computer system of claim 18, wherein the online content is displayed in a page that is framed by the host, and wherein a frame of the page displays at least a portion of the gist.

20. The computer system of claim 13, wherein the computer-executable instructions also include instructions that are executable to cause the computer system to, in response to receiving a user selection of a gist component at the one or more publishing sites, display a redirect page while redirecting to the online content.
